(19) United States
(12) Patent Application Publication
(10) Pub. No.: US 2007/0190314 A1
(43) Pub. Date: Aug. 16, 2007

(54) Transparent article and method for producing it, and lens substrate

(75) Inventors: Yasuhiro Aiki, Minami-ashigara-shi (JP); Tatsuhiko Obayashi, Minami-ashigara-shi (JP); Ryo Suzuki, Minami-ashigara-shi (JP); Hiroaki Mochizuki, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/653,393

(22) Filed: Jan. 16, 2007

(30) Foreign Application Priority Data
Jan. 13, 2006 (JP) 005600/2006

(51) Int. Cl. B32B 5/16

(52) U.S. Cl. 428/327; 428/333

(57) ABSTRACT

A transparent article having a thickness of at least 0.5 mm, which contains fine particles containing zirconium oxide as a main component in a resin and has a light transmittance of at least 60% at a wavelength of 405 nm and at least 70% at a wavelength of 589 nm in terms of the article having a thickness of 1 mm. The article has excellent transparency and high refractivity.

### BACKGROUND OF THE INVENTION

1. Field of the Invention

The present invention relates to a lens substrate that is constructed to include a transparent and lightweight, high-refractivity material composition (e.g., lens substrate to constitute lenses of eyeglasses, lenses for optical instruments, lenses for optoelectronics, lenses for lasers, lenses for pickups, lenses for in-vehicle cameras, lenses for portable cameras, lenses for digital cameras, lenses for OHP, microlens arrays).

2. Description of the Related Art

Optical materials are much studied these days, and especially in the field of lenses, it is strongly desired to develop lightweight materials having high refractivity, heat resistance, transparency, easy shapability, chemical resistance and solvent resistance.

As compared with inorganic materials such as glass, plastic lenses are lightweight and are hardly cracked, and they can be worked into various shapes. Accordingly these days, they are being much popularized not only for eyeglass lenses but also for other various optical materials such as lenses for portable cameras and pickup lenses.

With that, the plastic material itself for lenses is desired to have high refractivity for obtaining thin lenses and downsized pickup devices. For example, a technique of introducing a sulfur atom into polymer (see JP-A-2002-131502 and JP-A-10-298287); and a technique of introducing a halogen atom and an aromatic ring into polymer (see JP-A-2004-244444) are being much studied. However, a plastic material having a sufficiently high refractivity and having good transparency so as to be substitutive for glass is not as yet developed.

As another means for increasing the refractivity of resin, known is a method of uniformly dispersing high-refractivity inorganic fine particles in resin (see JP-A-61-291650, JP-A-2003-73559 and JP-A-2005-316219); and it is also known that zirconia is used as the inorganic fine particles (see JP-A-2001-89535, JP-A-2005-161111 and JP-A-2005-185924). Additivity may apply to refractivity, and therefore organic-inorganic hybrid technology is expected as a hopeful method for realizing a high-refractivity material of such a level that could hardly be attained by mere planning of a resin structure alone. However, when the method is applied to a thick article such as optical lenses, then the reduction in the transparency of the article caused by Rayleigh scattering produces a serious problem; and when the amount of the fine particles to be added to the article is increased to a level capable of realizing significant refractivity increase, then the article could not keep sufficient transparency. Other problems with the case are serious haze and discoloration increase though irradiation with light. Accordingly, no technology has heretofore been disclosed relating to high-refractivity transparent article having a thickness of 0.5 mm or more.

Accordingly, a plastic material that satisfies all the requirements of high refractivity, transparency and weight reduction, and an article such as a lens substrate comprising the material is as yet unknown, and it is desired to develop them.

### SUMMARY OF THE INVENTION

The invention has been made in consideration of the given situation as above, and its object is to provide an article having excellent transparency and high refractivity, in which fine particles are uniformly dispersed in a resin matrix, and a method for producing it; and to provide a lens substrate formed with the article.

We, the present inventors have assiduously studied for the purpose of attaining the above-mentioned object, and, as a result, have found that a material composition that comprises a high-refractivity transparent resin and specific inorganic fine particles compatible with the resin may exhibit high refractivity and excellent transparency owing to the uniform dispersion effect of the fine particles therein even though it is shaped into thick articles; and on the basis of this finding, we have completed the present invention.

Specifically, the invention is characterized by the following matters [1] to [11]:

[1] A transparent article having a thickness of at least 0.5 mm, which contains fine particles containing zirconium oxide as a main component in a resin and has a light transmittance of at least 60% at a wavelength of 405 nm and at least 70% at a wavelength of 589 nm in terms of the article having a thickness of 1 mm.

[2] The transparent article of [1], which contains at least 30% by mass of fine particles containing zirconium oxide as a main component.

[3] The transparent article of [1] and [2], wherein the fine particles containing zirconium oxide as a main component have a number-average particle size of from 1 to 7 nm.

[4] The transparent article of any one of [1] to [3], which has a refractive index at a wavelength of 589 nm of at least 1.7.

[5] The transparent article of any one of [1] to [4], which contains a compound having a group selected from 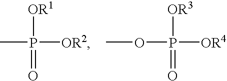
wherein R¹, R², R³ and R⁴ each independently represents a hydrogen atom or a substituted or unsubstituted alkyl group; —SO₃H; —OSO₃H; and —CO₂H.

[6] The transparent article of any one of [1] to [5], wherein the resin has a refractive index of from 1.58 to 1.80.

[7] A lens substrate comprising a transparent article of any one of [1] to [6].

[8] A method for producing a transparent article having a thickness of at least 0.5 mm and having a light transmittance at a wavelength of 405 nm of at least 60% and at a wavelength of 589 nm of at least 70% in terms of the article having a thickness of 1 mm; which comprises dispersing fine particles containing zirconium oxide as a main component in a resin.

[9] The method for producing a transparent article of [8], wherein the fine particles have a number-average particle size of from 1 to 7 nm.

[10] The method for producing a transparent article of [8] and [9], wherein the fine particles are dispersed in a resin in the presence of a dispersant.

[11] The method for producing a transparent article of [10], wherein the dispersant is a compound having a group selected from 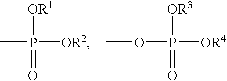
wherein R¹, R², R³ and R⁴ each independently represents a hydrogen atom or a substituted or unsubstituted alkyl group; —SO₃H; —OSO₃H; and —CO₂H.

In the transparent article of the invention, fine particles are uniformly dispersed in a resin matrix, and the article therefore has excellent transparency and high refractivity. In addition, the transparent article of the invention has good mechanical strength and light-proofness. According to the production method of the invention, the transparent article having such excellent properties can be produced efficiently. Using the transparent article of the invention provides an excellent lens substrate.

### BEST MODE FOR CARRYING OUT THE INVENTION

The transparent article, its production method and the lens substrate of the invention are described in detail hereinunder. The description of the constitutive elements of the invention given hereinunder may be for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

Material Composition:

The material composition to constitute the transparent article of the invention contains fine particles containing zirconium oxide as a main component in a resin. One preferred embodiment of the material composition is a composition of inorganic fine particles containing zirconium oxide as a main component dispersed in a high-refractivity resin.

The material composition is not specifically defined in point of its production method. Concretely, for example, herein employable is a method of independently producing a resin and inorganic fine particles and mixing them; a method of producing a resin in the presence of previously-produced inorganic fine particles; a method of producing inorganic fine particles in the presence of a previously-produced resin; and a method of simultaneously producing both the resin and the inorganic fine particles. Any of these methods may be used for producing the material composition of the invention.

For example, when a method of independently producing a resin and inorganic fine particles and mixing them is employed, then the inorganic fine particles and the resin solution may be stirred and mixed; or a dispersion of the inorganic fine particles and the resin solution may be stirred and mixed. In this case, the inorganic fine particles or their dispersion may be mixed with the resin solution all at a time, or the former may be gradually and dropwise added to the latter. When they are stirred and mixed, the system comprising them may contain a plasticizer or a dispersant existing therein. The plasticizer and the dispersant may be previously added to the resin solution or the inorganic fine particles dispersion, or may be added to the mixture of the resin solution and the inorganic fine particles.

Preferably, the material composition of the invention has a light transmittance of at least 60% at a wavelength of 405 nm, more preferably at least 65%, even more preferably at least 70%. Also preferably, the material composition has a light transmittance of at least 70% at a wavelength of 589 nm, more preferably at least 75%, even more preferably at least 80%. When the light transmittance at a wavelength of 589 nm of the material composition is at least 80%, then the composition may readily give a lens substrate having good properties. The light transmittance as referred to herein is a value measured as follows: The material composition to be analyzed is shaped into a substrate having a thickness of 1.0 mm, and not coated with an antireflection layer, this is measured with a UV-visible ray spectrometric device, UV-3100 (by Shimadzu). The value therefore includes the transmittance reduction by reflection on the surface and the back of the article. When the material is used for an optical lens or the like, the lens surface is generally coated with an antireflection layer. The light transmittance at a wavelength of 589 nm of the article coated with such an antireflection layer formed thereon is preferably at least 80%, more preferably at least 85%, even more preferably at least 90%.

Preferably, the glass transition temperature of the material composition of the invention is from 100° C. to 400° C., more preferably from 130° C. to 380° C. When the glass transition temperature is at least 100° C., then the material composition may readily have good heat resistance; and when the glass transition temperature is at most 400° C., then the material composition may be readily shaped.

Fine Particles:

In the invention, fine particles containing zirconium oxide as a main component are dispersed in a resin. Fine particles containing zirconium oxide as a main component as referred to herein mean that the proportion of zirconium element in the fine particles is at least 50% by mass. Preferably, the proportion of zirconium element in the fine particles for use in the invention is at least 55% by mass, more preferably at least 60% by mass. From the viewpoint of the refractivity, the transparency and the stability thereof, the fine particles in the invention may also be a composite with any other inorganic substance than zirconium oxide. The other inorganic substance than zirconium oxide includes oxides, sulfides, selenides, tellurides. More concretely, they are titanium oxide, zinc oxide, tin oxide, zinc sulfide, to which, however, the invention should not be limited. Preferably, the fine particles have a refractive index of from 2.0 to 2.3.

The zirconium oxide fine particles for use in the invention are not specifically defined in point of their production method, and they may be produced in any known method. For example, for obtaining zirconium oxide fine particles or their suspension, herein employable are a method comprising neutralizing an aqueous solution of a zirconium salt with alkali to give zirconium hydrate followed by drying and calcining it, and dispersing it in a solvent to produce a zirconium oxide suspension; a method comprising hydrolyzing an aqueous solution of a zirconium salt to produce a zirconium oxide suspension; a method comprising hydrolyzing an aqueous solution of a zirconium salt to give a zirconium oxide suspension and then ultra-filtering it; a method comprising hydrolyzing a zirconium alkoxide to obtain a zirconium oxide suspension; and a method comprising heating an aqueous solution of a zirconium salt under hydraulic pressure to produce a zirconium oxide suspension. Any of these methods may be employed for producing the particles.

Regarding the number-average particle size of the zirconium oxide fine particles for use in the invention, when the particle size is too small, then the properties intrinsic to the substance that constitute the fine particles may change; but on the contrary, when the particle size is too large, then the influence of Rayleigh scattering on the particles may be great with the result that the transparency of the material composition may extremely lower. Accordingly, the lowermost limit of the number-average particle size of the inorganic fine particles for use in the invention is preferably 1 nm, more preferably 2 nm, even more preferably 3 nm; and the uppermost limit thereof is preferably 7 nm, more preferably 6 nm, even more preferably 5 nm. Preferably, the zirconium oxide content of the material composition is from 30 to 90% by mass, more preferably from 35 to 80% by mass, even more preferably from 40 to 80% by mass.

Dispersant:

In the invention, the zirconium oxide fine particles are preferably dispersed in a resin in the presence of a dispersant therein. The preferred range of the number-average particle size of the zirconium oxide fine particles dispersed in a resin is the same as that (mentioned in the above) of the number-average particle size of the zirconium oxide fine particles for use in the invention.

Since the zirconium oxide fine particles for use in the invention have a small particle size and have a high surface energy level, they could be hardly redispersed when they are isolated as solid. Accordingly, it is desirable that the zirconium oxide fine particles dispersed in water or alcohol are extracted with a dispersant into an organic solvent, and then mixed with monomer or polymer.

The dispersant to be used for extraction may be the same as or different from that used in dispersing the particles in resin. In case where the two differ, then the former dispersant is used after subjected to ligand exchange in an organic solvent.

The molecular weight of the dispersant for use in the invention may be generally from 50 to 10000, more preferably from 100 to 5000, even more preferably from 200 to 1000. A compound capable of polymerizing during a shaping step to have an increased molecular weight is also preferably used as the dispersant. It is also preferable that the resin matrix to serve as the essential ingredient of the composition has a fine particles-dispersing group.

When the fine particles for use in the invention are coordinated or modified with an organic compound compatible with the resin matrix that consists essentially of resin mentioned below, then the dispersibility of the fine particles in the resin matrix may increase with the result that the transparency and the mechanical strength of the material composition of the invention may increase. The organic compound of the type is also preferred for the dispersant in the invention. The effect of the dispersant of the type may be a combination of the effect thereof to inhibit aggregation of fine particles and the effect thereof to improve the compatibility of the fine particles with a resin matrix.

A preferred structure of the dispersant of the type is represented by the following general formula (1):
A-R (1)
wherein A represents a functional group capable of forming a chemical bond to the surface of fine particles; R represents a monovalent group having from 1 to 30 carbon atoms or a polymer compatible or reactive with a resin matrix. The chemical bond includes, for example, covalent bond, ionic bond, coordinate bond, hydrogen bond.

Examples of A that bonds to zirconium oxide fine particles include the following: 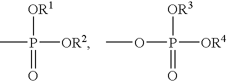
[wherein R¹, R², R³ and R⁴ each independently represents a hydrogen atom or a substituted or unsubstituted alkyl group], —SO₃H, —OSO₃H, —CO₂H, —Si(OR⁵)ₘR⁶₃₋ₘ, —Al(OR⁷)₂, —Ti(OR⁸)₃ [wherein R⁵, R⁶, R⁷ and R⁸ each independently represents a hydrogen atom, a substituted or unsubstituted alkyl group, a substituted or unsubstituted alkenyl group, a substituted or unsubstituted alkynyl group, or a substituted or unsubstituted aryl group; and m indicates an integer of from 1 to 3]; preferably the following: 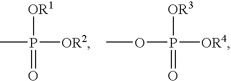
—SO₃H, —OSO₃H, —CO₂H;
more preferably the following:

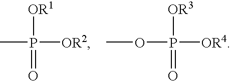

The alkyl group for R¹ to R⁴may have an unsaturated bond and a hydroxyl group. The unsaturated bond is preferably a carbon-carbon double bond.

On the other hand, R is a group compatible or reactive with a resin matrix, and its chemical structure is preferably the same as or similar to a part or all of the chemical structure of the resin that is the essential part of the resin matrix. Preferably, R is a group having an aromatic group (e.g., a phenyl group, a benzyl group, a 4-n-octylphenyl group) and a group having a reactive unsaturated group (e.g., an alkyl group having acryloyl group and/or methacryloyl group).

Examples of the dispersant preferably used in the invention are KAYAMER PM-21, KAYAMER PM-2 (both trade names by Nippon Kayaku), PHOSMER PE, PHOSMER PP (both trade names by Unichemical), phenylphosphonic acid, dibenzyl phosphate, 4-vinylbenzenesulfonic acid, vinylsulfonic acid, paratoluenesulfonic acid, 4-vinylbenzoic acid, β-carboxyethyl acrylate.

One or more different types of such dispersants may be used herein either singly or as combined.

The amount of the dispersant to be added to the composition is preferably from 5 to 200% by mass of the solid content of the zirconia fine particles in the composition, more preferably from 10 to 100% by mass, even more preferably from 20 to 50% by mass.

Resin:

The resin for use in the invention may be any of thermoplastic resin, or resin capable of being cured by the action of active energy rays such as UV rays or electron beams applied thereto. When the resin is a thermoplastic resin, then its glass transition temperature is preferably from 80° C. to 400° C., more preferably from 130° C. to 380° C. When a resin having a glass transition temperature of 80° C. or higher is used, then optical structures having sufficient heat resistance may be readily obtained; and when a resin having a glass transition temperature of 400° C. or lower is used, then the resin composition may be readily shaped and worked.

Preferably, the resin for use in the invention has a light transmittance at a wavelength of 400 nm and 589 nm of at least 80%, more preferably at least 85%, in terms of the resin article having a thickness of 1 mm. Like that of the material composition mentioned hereinabove, the light transmittance as referred to herein is a value measured in the absence of an antireflection film. The value therefore includes the transmittance reduction by light reflection on the surface and the back of the resin sample. Preferably, the refractive index of the resin for use in the invention is from 1.58 to 1.80 at a wavelength of 589 nm, more preferably from 1.60 to 1.80, even more preferably from 1.65 to 1.80. The refractive index as referred to herein is a value measured with an Abbe's refractiometer (Atago's DR-M4) for light having a wavelength of 589 nm.

Preferred examples of the thermoplastic resin usable in the invention are mentioned below, to which, however, the invention should not be limited. x and y for the repetitive units indicate a copolymerization ratio (by mol).

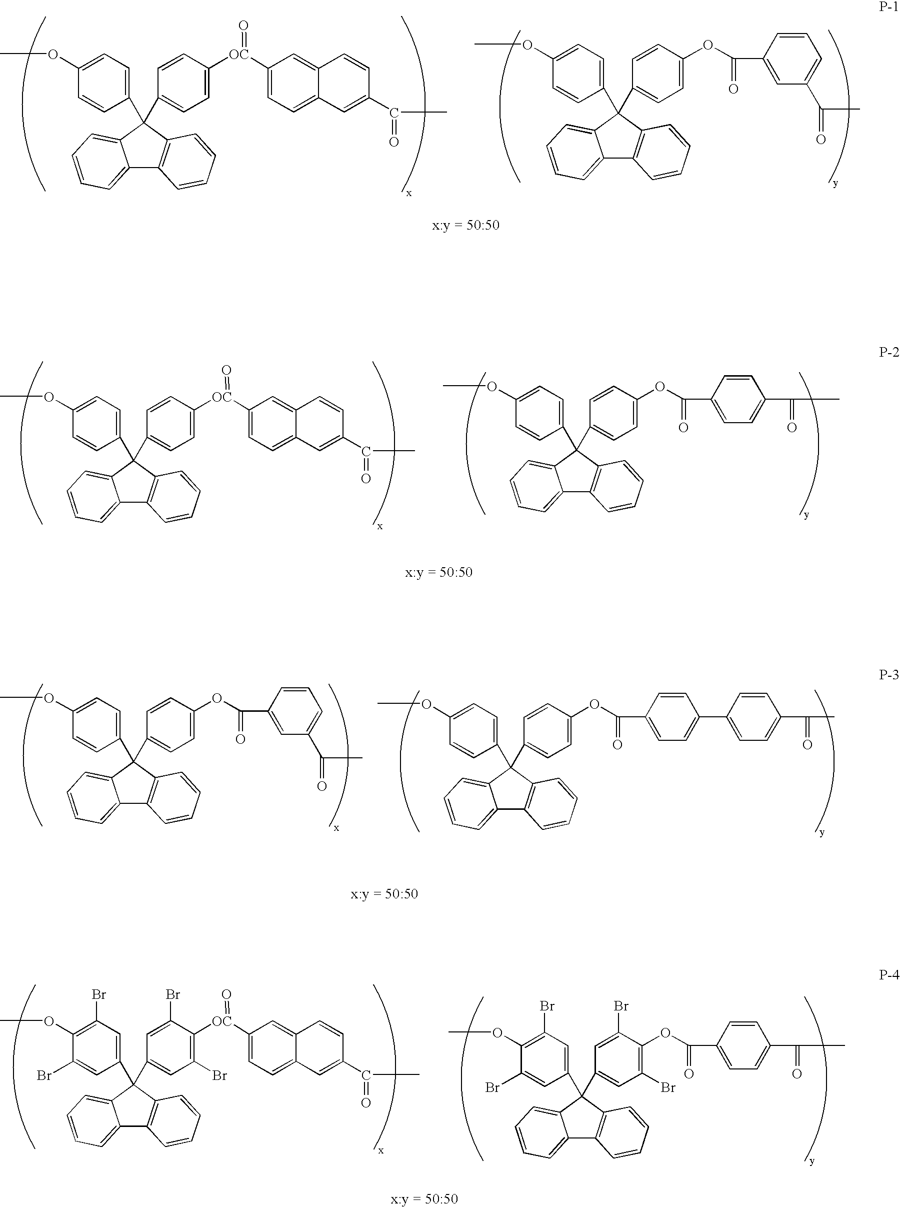

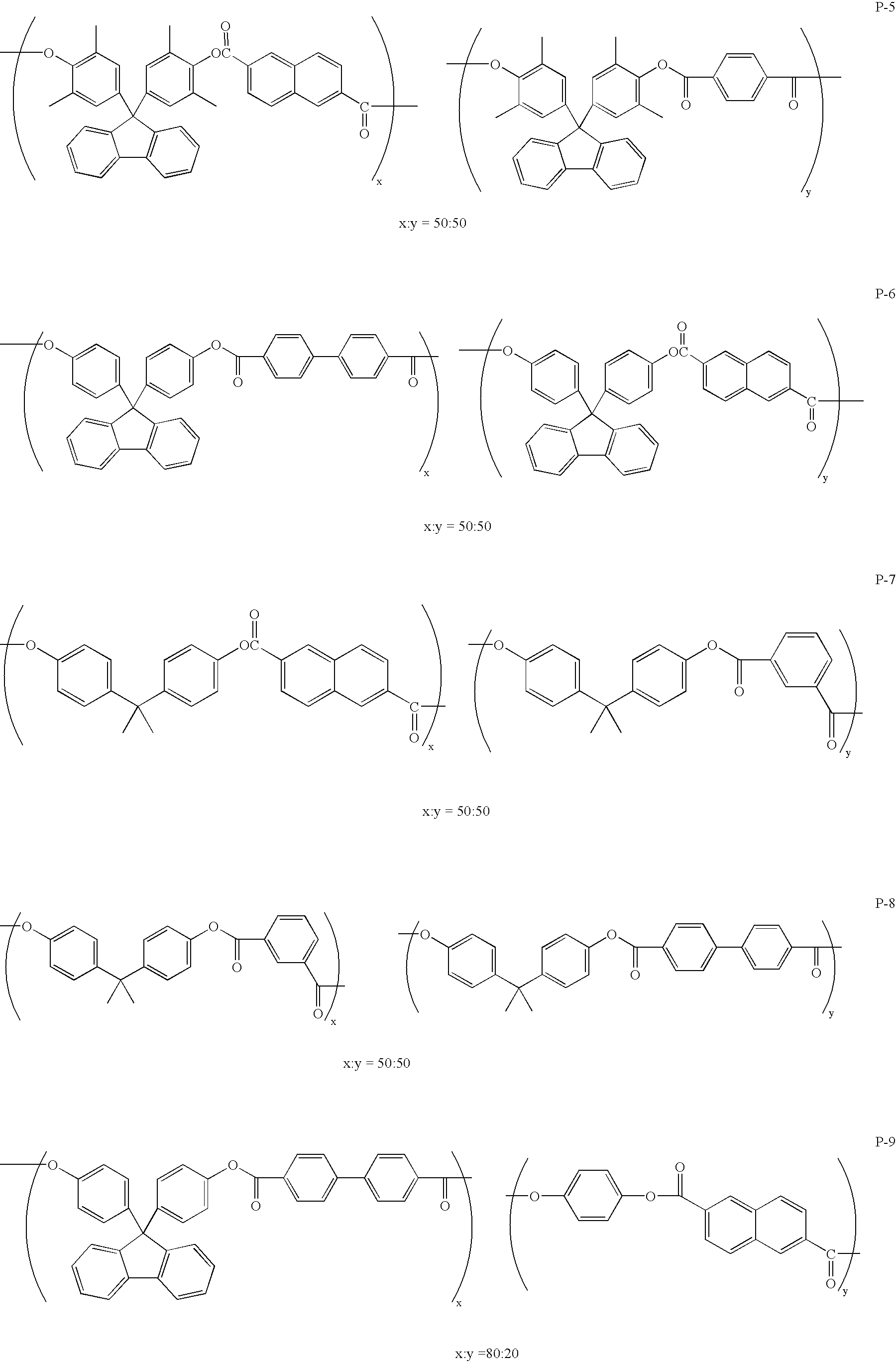

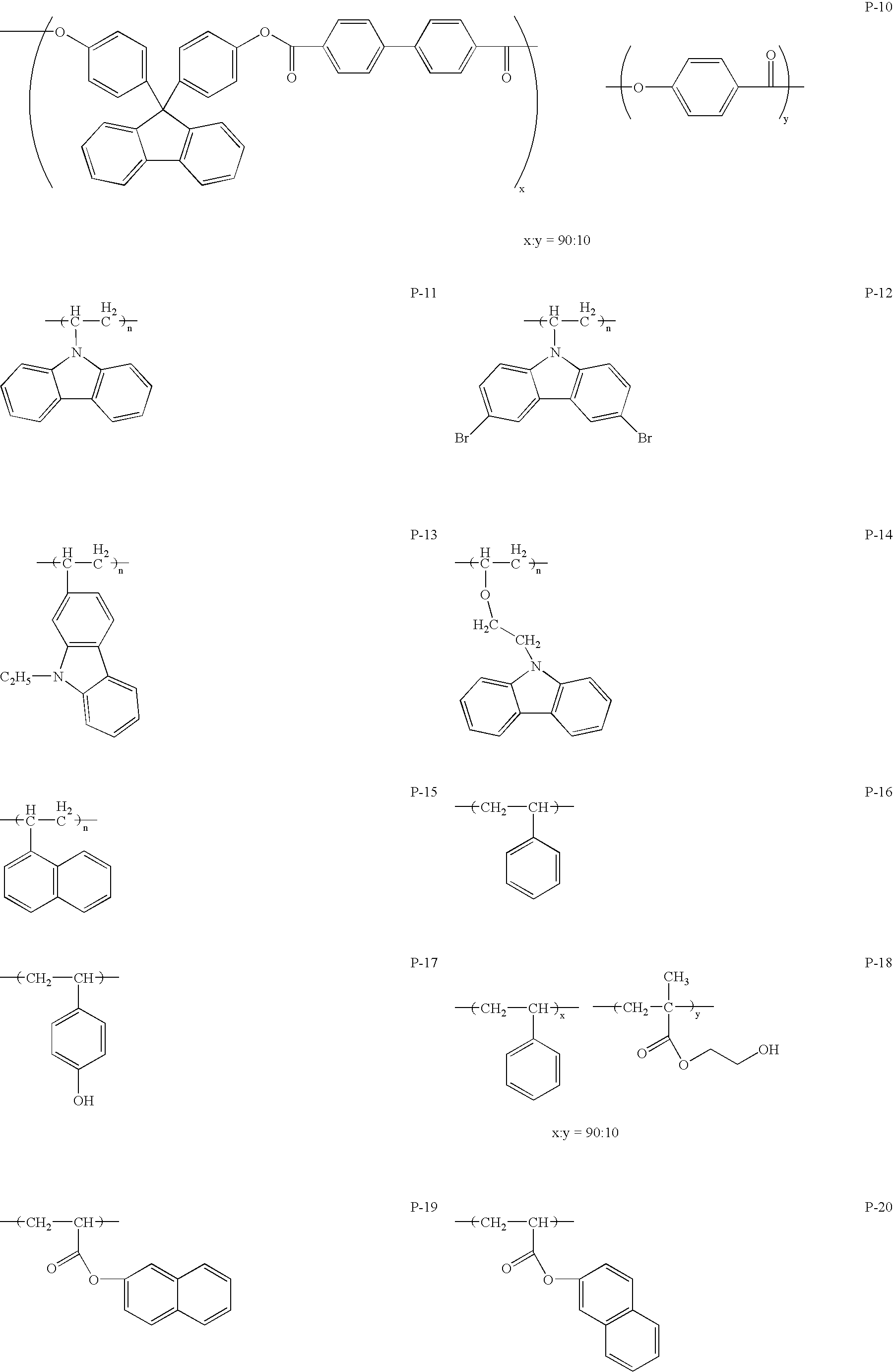

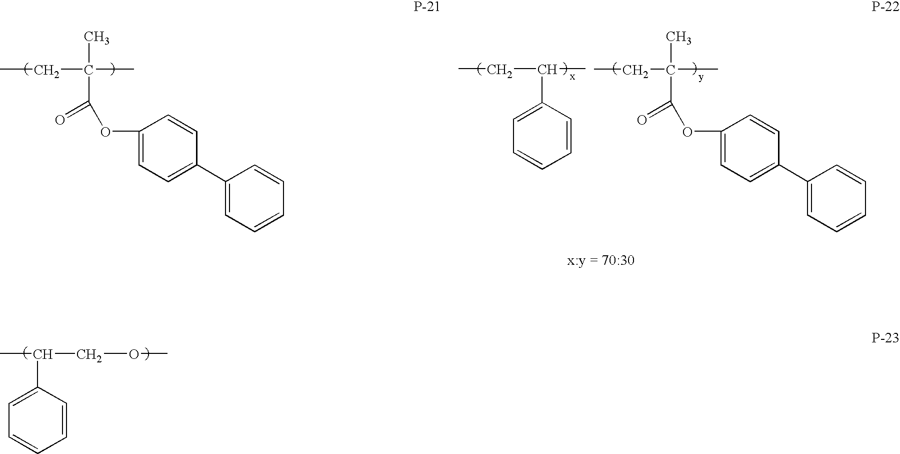

In addition, sulfur-containing, high-refractivity thermoplastic resins as in JP-A-11-202101, JP-A-7-316295, JP-A-8-92367, JP-A-8-104751, JP-A-8-100065, JP-A-5-178929, JP-A-7-267919 are also usable herein.

One or more these resins may be used either singly or as combined.

Preferred examples of resins capable of being cured by the action of heat or active energy rays applied thereto, which are preferably used in the invention, are mentioned below, to which, however, the invention should not be limited. In the following, M-1 to M-7 are shown as monomers.

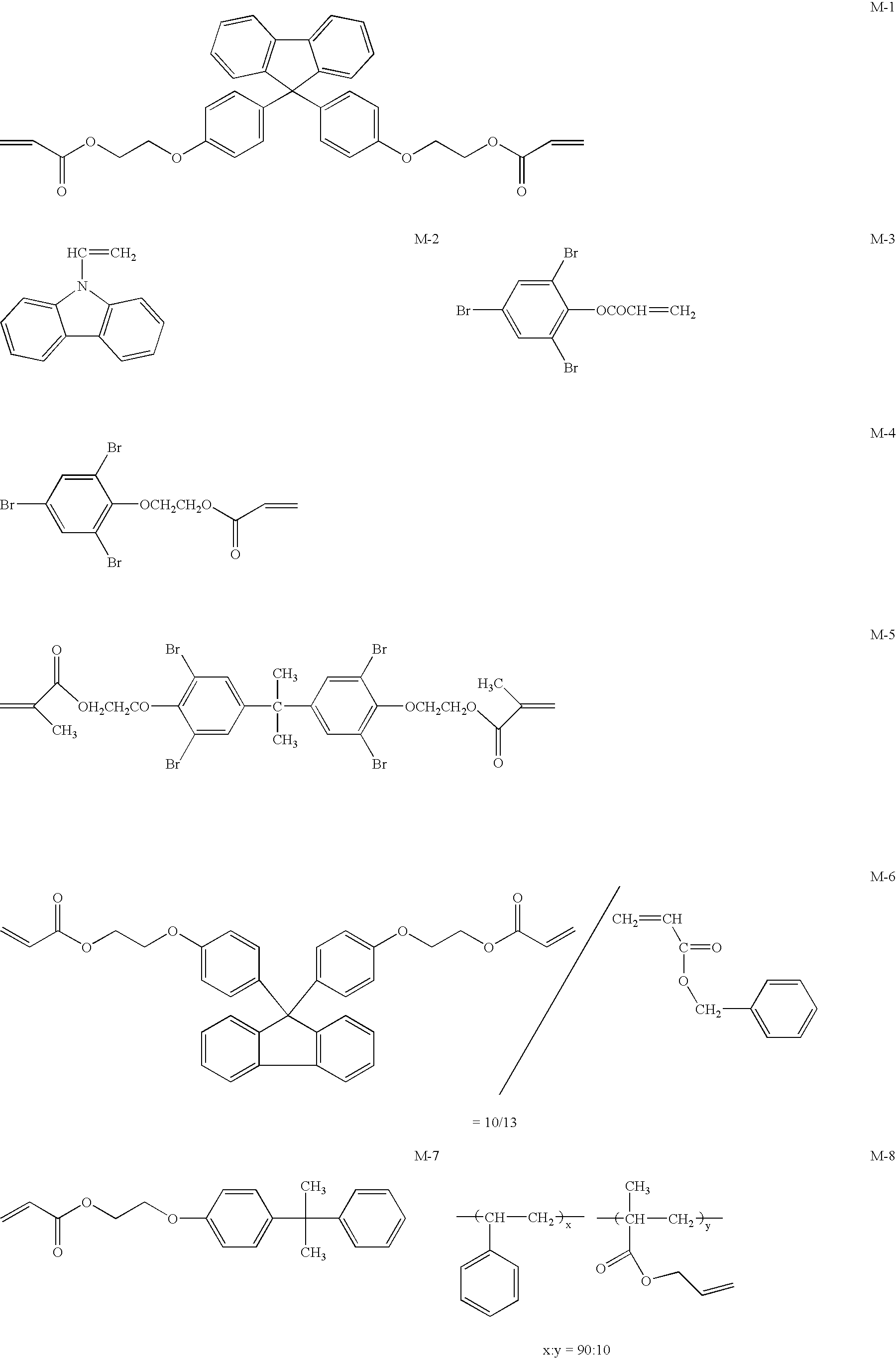

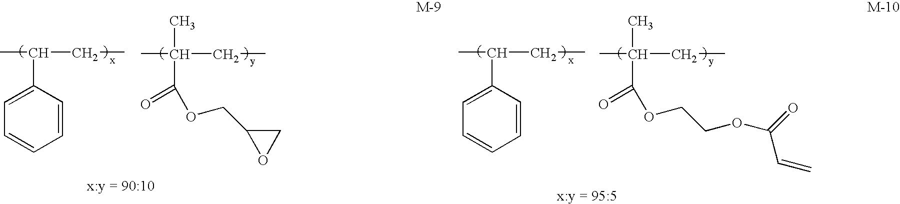

In addition, sulfur-containing curable resins as in JP-A-5-148340, JP-A-5-208950, JP-A-6-192250, JP-A-7-252207, JP-A-9-110979, JP-A-9-255781, JP-A-10-298287, JP-A-2001-342252, JP-A-2002-131502 are also preferably used in the invention.

For efficiently curing the monomer to form a resin as above, a polymerization initiator may be used in the invention.

A radical polymerization initiator may be used herein, which may be either one that generates a radical by the action of heat applied thereto, or one that generates a radical by the action of light applied thereto.

A compound that initiates radical polymerization by the action of heat applied thereto includes organic or inorganic peroxides, organic azo or diazo compounds.

Concretely, organic peroxides include benzoyl peroxide, halogenobenzoyl peroxide, lauroyl peroxide, acetyl peroxide, dibutyl peroxide, cumemehydroperoxide, butylhydroperoxide; inorganic peroxides include hydrogen peroxide, ammonium persulfate, potassium persulfate; azo compounds include 2-azobisisobutyronitrile, 2-azobispropionitrile, 2-azobiscyclohexane-dinitrile; diazo compounds include diazoaminobenzene, p-nitrobenzene-diazonium.

When the compound that initiates radical polymerization by the action of light applied thereto is used, then the monomer is cured through irradiation with active energy rays.

Examples of such a photoradical polymerization initiator are acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums. Examples of acetophenones are 2,2-diethoxyacetophenone, p-dimethylacetophenone, 1-hydroxydimethylphenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone. Examples of benzoins are benzoin benzenesulfonate, benzoin toluenesulfonate, benzoin methyl ether, benzoin ethyl ether, benzoin isopropyl ether. Examples of benzophenones are benzophenone, 2,4-dichlorobenzophenone, 4,4-dichlorobenzophenone, p-chlorobenzophenone. Examples of phosphine oxides are 2,4, 6-trimethylbenzoyldiphenylphosphine oxide. Preferably, sensitizing dye may be combined with the photoradical polymerization initiator.

The amount of the compound to be used herein, which initiates radical polymerization by the action of heat or light applied thereto, may be any one capable of initiating the intended polymerization, but in general, it may be from 0.1 to 15% by mass of the overall solid content of the resin composition, more preferably from 0.5 to 10% by mass, even more preferably from 2 to 5% by mass.

The cationic polymerization initiator usable in the invention includes proton acids such as toluenesulfonic acid, methanesulfonic acid; quaternary ammonium salts such as triethylbenzylammonium chloride, tetramethylammonium chloride; tertiary amines such as benzyldimethylamine, tributylamine, tris(dimethylamino)methylphenol; imidazole compounds such as 2-methyl-4-ethylimidazole, 2-methylimidazole; compounds capable of thermally decomposing to generate a proton acid, such as cyclohexyl toluenesulfonate, isopropyl toluenesulfonate; other various compounds capable of generating an acid catalyst by the action of light applied thereto, such as those mentioned below. In the invention, especially preferably used are compounds capable of generating an acid by the action of light applied thereto.

Various compounds capable of generating an acid by the action of light applied thereto are described, for example, in Organic Materials for Imaging, edited by the Society of Organic Electronics Material Study, pp. 187-198, or in JP-A-10-282644; and such known compounds are usable in the invention. Concretely, they include various onium salts such as diazonium salts, ammonium salts, phosphonium salts, iodonium salts, sulfonium salts, selenonium salts and arsonium salts, taking a counter ion of RSO₃⁻ (where R represents an alkyl group or an aryl group), AsF₆⁻, SbF₆⁻, PF₆⁻, BF₄⁻ or the like: organic halides such as trihalomethyl group-substituted oxadiazole derivatives and S-triazine derivatives; o-nitrobenzyl esters, benzoin esters, imino esters and disulfone compounds of organic acids. Preferred are onium salts; more preferred are sulfonium salts and iodonium salts.

Preferably, sensitizing dye may be combined with the compound capable of generating an acid by the action of light applied thereto.

Like that of the radical initiator, the amount of the compound that initiates cationic polymerization by the action of heat or light applied thereto, which is added to the resin composition, may be, in general, preferably from 0.1 to 15% by mass of the overall solid content of the resin composition, more preferably from 0.5 to 10% by mass, even more preferably from 2 to 5% by mass.

Plasticizer:

When the glass transition temperature of the resin used in the invention is high, then it may be not always easy to shape the resin composition. Accordingly, a plasticizer may be used for lowering the shaping temperature of the composition. Preferably, the plasticizer for use in the invention has a structure of the following general formula (2): 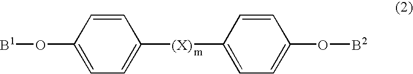
wherein B¹ and B² each represents an alkyl group having from 6 to 18 carbon atoms, or an arylalkyl group having from 6 to 18 carbon atoms; m indicates 0 or 1; X represents any of the following: 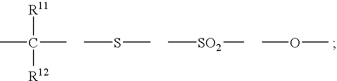
R¹¹ and R¹² each independently represents a hydrogen atom or an alkyl group having at most 4 carbon atoms.

In the compounds of formula (2), B¹and B² may be an alkyl or arylalkyl group having from 6 to 18 carbon atoms. When the group has less than 6 carbon atoms, then the molecular weight of the compound is too low and the compound may boil at the melting temperature of polymer and may form bubbles. When the group has more than 18 carbon atoms, then the compound may be poorly compatible with polymer and could not exhibit its effect when added to polymer.

Examples of the groups of B¹ and B² are a linear alkyl group such as an n-hexyl group, an n-octyl group, an n-decyl group, an n-dodecyl group, an n-tetradecyl group, an n-hexadecyl group, an n-octadecyl group; a branched alkyl group such as a 2-hexyldecyl group, a methyl-branched octadecyl group; and an arylalkyl group such as a benzyl group, a 2-phenylethyl group. Examples of the compound of formula (2) for use in the invention are mentioned below, to which, however, the invention should not be limited. Above all, W-1 (Kao's trade name, KP-L155) is preferred. 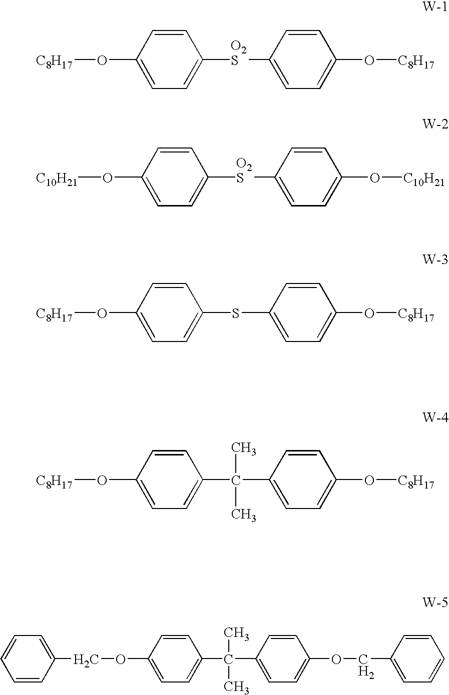
Shaping Method:

For shaping the organic-inorganic hybrid material in the invention, employable is any known shaping method for ordinary thermoplastic resin material, such as injection molding, extrusion, compression molding or casting. In the invention, compression molding is preferred since the flowability of the organic-inorganic hybrid material is low.

Transparent Article:

The transparent article of the invention has a thickness of at least 0.5 mm, preferably from 0.5 to 5 mm, more preferably from 0.7 to 3 mm, even more preferably from 1 to 2 mm. Accordingly, the transparent article of the invention is favorably used as a member that must be thick in some degree, such as optical lenses. The refractive power of a lens is determined by the curvature (thickness) and the refractive index thereof. In planning optical lenses for use in mobile phones and digital cameras, the lenses must have a thickness of at least 0.5 mm, and therefore the lenses must have both the intended refractive index and the transparency while having the thickness of the level. However, conventional known resin articles could not satisfy both the two to a practicable level.

The transparent article of the invention is characterized in that it has a thickness of at least 0.5 mm and has high visible range transparency. Concretely, the article has a light transmittance at a wavelength of 405 nm of at least 60%, preferably at least 65%, more preferably at least 70%, in terms of the thickness thereof of 1 mm; and has a light transmittance at a wavelength of 589 nm of at least 70%, preferably at least 75%, more preferably at least 80%, in terms of the thickness thereof of 1 mm.

Lens Substrate:

When the transparent article of the invention is applied to an optical lens, then its application is preferably such that it is used for correction of chromatic aberration as combined with a lens having a high Abbe's number, concretely an Abbe's number of from 45 to 60. In this case, it is desirable that the transparent article has an Abbe's number of from 20 to 35 or so. The lens substrate of the invention is lightweight and has high refractivity and good light transmissibility, and therefore has excellent optical properties. When the type of the monomer to constitute the material composition and the amount of zirconium oxide to be dispersed in the composition are suitably varied and controlled, then the refractive index of the lens substrate of the invention can be varied and controlled in any desired manner.

“Lens substrate” as referred to in the invention means a single structure capable of exhibiting a lens function. A film or an additional structure may be provided on the surface of the lens substrate or around the periphery thereof, depending on the service condition and the application of lens. For example, a protective film, an antireflection film and a hard coat film may be formed on the surface of the lens substrate. The periphery of the lens substrate may be fitted into a substrate-holding frame and fixed therein. However, these film and frame are additional structures to the lens substrate of the invention, and should be differentiated from the lens substrate itself of the invention.

For lens applications, the lens substrate of the invention may be singly used as a lens by itself, or a film or a frame may be added thereto to form a lens structure as in the above. The type and the shape of the lens that comprises the lens substrate of the invention are not specifically defined. The lens substrate of the invention may be used, for example, for lenses for eyeglasses, lenses for optical instruments, lenses for optoelectronics, lenses for lasers, lenses for pickups, lenses for in-vehicle cameras, lenses for portable cameras, lenses for digital camera, lenses for OHP, microlens arrays, etc.

Other Applications:

The transparent article of the invention is also usable for optical parts that utilize the excellent optical properties of the material composition, especially for light-transmitting optical parts (passive optical parts) . Examples of functional devices provided with such optical parts are various display devices (e.g., liquid-crystal displays, plasma displays), various projector devices (e.g., OHP, liquid-crystal projectors), optical fiber communication devices (e.g., optical waveguides, optical amplifiers), and pickup devices such as cameras, video recorders. Examples of the passive optical parts in such optical functional devices are lenses, prisms, prism sheets, panels, films, optical waveguides, optical discs, LED sealants, etc.

### EXAMPLES

The characteristics of the invention are described more concretely with reference to the following Examples. In the following Examples, the material used, its amount and ratio, the details of the treatment and the treatment process may be suitably modified or changed not overstepping the sprit and the scope of the invention. Accordingly, the invention should not be limited to the Examples mentioned below.

Method for Analysis and Evaluation:

(1) X-ray Diffraction (XRD) Spectrometry:

Using Rigaku's RINT1500 (X-ray source: copper Kα ray, wavelength 1.5418 angstroms), a sample is analyzed at 23° C.

(2) Transmission Electromicroscope (TEM) Observation:

Using Hitachi's TEM microscope, H-9000 UHR Model (accelerating voltage, 200 kV; vacuum degree in observation, about 7.6×10⁻⁹ Pa), a sample is analyzed.

(3) Measurement of Light Transmittance:

A resin to be analyzed is shaped into a substrate having a thickness of 1.0 mm, and this is analyzed with a UV-visible ray spectrometric device, UV-3100 (by Shimadzu).

(4) Measurement of Refractive Index:

Using an Abbe's refractiometer (Atago's DR-M4), a sample is analyzed for light having a wavelength of 589 nm.

Production of Material Composition:

### Example 1

(1) Preparation of Zirconium Oxide Fine Particles:

A zirconium oxychloride solution having a concentration of 50 g/liter was neutralized with aqueous 48% sodium hydroxide solution to obtain a zirconium hydrate suspension. The suspension was filtered, and then washed with ion-exchanged water to obtain zirconium hydrate cake. The cake was dissolved in ion-exchanged water serving as a solvent to prepare a solution having a concentration of 15% by mass in terms of zirconium oxide therein. This was put into an autoclave, and subjected to hydrothermal treatment at 150° C. under a pressure of 150 atmospheres for 24 hours to obtain a suspension of zirconium oxide fine particles. TEM confirmed the formation of zirconium oxide fine particles having a number-average particle size of 5 nm. In the same manner as above but reacting the components to give a concentration of 17% by mass or 19% by mass in terms of zirconium oxide in the suspension, zirconium oxide fine particles having a number-average particle size of 7 nm or 9 nm were produced. The zirconium oxide content of each kind of the thus-obtained zirconium oxide fine particles was at least 95% by mass which was estimated by the analysis with ICP-MS. A small amount of chloride ion, sodium ion, potassium ion and hafnium ion were detected in addition to zirconium oxide.

(2) Preparation of Toluene Dispersion of Zirconium Oxide Fine Particles:

The aqueous dispersion of zirconium oxide having a number-average particle size of 5 nm prepared in (1) and a toluene solution of Nippon Kayaku's KAYAMER PM-21 (trade name) were mixed, then stirred at 50° C. for 8 hours, and the toluene solution was extracted out to prepare a toluene dispersion of zirconium oxide fine particles.

(3) Production of Lens Substrate by Thermal Molding:

The toluene dispersion of zirconium oxide fine particles prepared in (2) was mixed with a monomer M-1 and azobisisobutyronitrile, and the solvent was removed to produce a mixture of zirconium oxide fine particles and the monomer M-1. The mixture was cast into a mold having a thickness of 1 mm, and polymerized at 30° C. for 1 hour, at 50° C. for 1 hour, at 70° C. for 1 hour and at 100° C. for 1 hour to obtain a molded article (lens substrate) having a thickness of 1 mm. The molded article was cut, and its cross section was observed with TEM, which confirmed uniform dispersion of inorganic fine particles in resin. The data in light transmittance measurement and refractive index measurement are shown in Table 1.

### Examples 2 to 13, Comparative Examples 1 and 6:

A molded article having a thickness of 1 mm was produced in the same manner as in Example 1. In this, however, the type of monomer, the particle size and the amount added of zirconium oxide, and the dispersant were changed as in Table 1. The light transmittance and the refractive index of the molded article were measured. The molded article was cut, and its cross section was observed with TEM to confirm uniform dispersion of fine particles in the matrix. The data are shown in Table 1.

### Comparative Example 2

(1) Production of Titanium Oxide Fine Particles:

According to JP-A-2003-73559, titanium oxide fine particles were produced. XRD and TEM confirmed the formation of anatase-type titanium oxide fine particles (having a number-average particle size of about 5 nm).

(2) Production of Lens Substrate by Thermal Molding:

Titanium oxide fine particles produced in (1) were suspended in 1-butanol, then ultrasonically treated for 30 minutes, and heated at 100° C. for 30 minutes. The resulting cloudy liquid was dropwise added to a chloroform solution of a monomer M-1 having a concentration of 10% by mass, with stirring at room temperature, taking 5 minutes. The solvent was evaporated away from the resulting mixture, and this was cast into a mold having a thickness of 1 mm, and polymerized at 30° C. for 1 hour, at 50° C. for 1 hour, at 70° C. for 1 hour and at 100° C. for 1 hour to obtain a molded article (lens substrate) having a thickness of 1 mm.

The molded article was cut, and its cross section was observed with TEM, which confirmed uniform dispersion of inorganic fine particles in resin. The data in light transmittance measurement and refractive index measurement are shown in Table 1.

### Comparative Examples 3 to 5

A molded article having a thickness of 1 mm was produced in the same manner as in Comparative Example 1. In this, however, the monomer was changed from M-1 to M-2; and the amount of titanium oxide added and the amount of the dispersant added were changed as in Table 1. The molded article obtained in Comparative Examples 3 to 5 was cut, and its cross section was observed with TEM, which confirmed uniform dispersion of inorganic fine particles in resin. The data in light transmittance measurement and refractive index measurement are shown in Table 1.

### Comparative Examples 7 to 10

Not adding inorganic fine particles thereto, the resin alone was molded, and the light transmittance and the refractive index of the molded article were measured. The data are given in the following Table 1.

TABLE 1

| | | Inorganic Fine Particles | | | Dispersant | | Evaluation of Molded Article | | | |
|---|---|---|---|---|---|---|---|---|---|---|
| | | | Particle | Amount | | Amount | Dispersibility | Transmittance (%) | | |
| | Type of | | Size | Added | | Added | of Inorganic | 405 | 589 | Refractive |
| | monomer | Type | (nm) | (mas. %) | Type | (mas. %) | Fine Particles | nm | nm | Index |
| Example 1 | M-1 | ZrO₂ | 5 | 68 | PM-21 | 20 | ∘ | 74 | 81.8 | 1.76 |
| Example 2 | M-1 | ZrO₂ | 7 | 68 | PM-21 | 20 | ∘ | 73.8 | 80 | 1.75 |
| Example 3 | M-2 | ZrO₂ | 5 | 33 | PM-21 | 10 | ∘ | 75 | 84 | 1.72 |
| Example 4 | M-2 | ZrO₂ | 5 | 45 | PM-21 | 14 | ∘ | 74.7 | 83 | 1.74 |
| Example 5 | M-2 | ZrO₂ | 5 | 56 | PM-21 | 16 | ∘ | 72.2 | 82 | 1.76 |
| Example 6 | M-2 | ZrO₂ | 5 | 68 | PM-21 | 20 | ∘ | 68 | 80 | 1.79 |
| Example 7 | M-2 | ZrO₂ | 5 | 45 | p- | 14 | ∘ | 69 | 82 | 1.75 |
| | | | | | Toluenesulfonic | | | | | |
| | | | | | acid | | | | | |
| Example 8 | M-2 | ZrO₂ | 5 | 45 | Dibenzyl | 14 | ∘ | 70 | 82 | 1.74 |
| | | | | | phosphate | | | | | |
| Example 9 | M-2 | ZrO₂ | 5 | 25 | Dibenzyl | 10 | ∘ | 73 | 81 | 1.71 |
| | | | | | phosphate | | | | | |
| Example 10 | M-2 | ZrO₂ | 5 | 45 | Phenyl | 14 | ∘ | 72 | 82 | 1.74 |
| | | | | | phosphonic | | | | | |
| | | | | | acid | | | | | |
| Example 11 | M-2 | ZrO₂ | 5 | 45 | Benzoic acid | 14 | ∘ | 73 | 82 | 1.73 |
| Example 12 | M-10 | ZrO₂ | 5 | 58 | PM-21 | 17 | ∘ | 67.5 | 75 | 1.72 |
| Example 13 | M-18 | ZrO₂ | 5 | 58 | PM-21 | 17 | ∘ | 68 | 78.5 | 1.72 |
| Comparative | M-1 | ZrO₂ | 9 | 68 | PM-21 | 20 | ∘ | 39.2 | 56 | 1.75 |
| Example 1 | | | | | | | | | | |
| Comparative | M-1 | TiO₂ | 5 | 39 | PM-21 | 12 | ∘ | 48 | 67.8 | 1.76 |
| Example 2 | | | | | | | | | | |
| Comparative | M-2 | TiO₂ | 5 | 29 | PM-21 | 9 | ∘ | 53.7 | 68.8 | 1.76 |
| Example 3 | | | | | | | | | | |
| Comparative | M-2 | TiO₂ | 5 | 37 | PM-21 | 12 | ∘ | 46.8 | 66.9 | 1.79 |
| Example 4 | | | | | | | | | | |
| Comparative | M-2 | TiO₂ | 5 | 9 | PM-21 | 3 | ∘ | 57 | 82 | 1.695 |
| Example 5 | | | | | | | | | | |
| Comparative | M-2 | ZrO₂ | 5 | 45 | Phenyl | 14 | x | 0 | 0 | unmeasurable |
| Example 6 | | | | | trimethoxysilane | | | (cloudy) | (cloudy) | |
| Comparative | M-1 | — | — | — | — | — | — | 85 | 86 | 1.62 |
| Example 7 | | | | | | | | | | |
| Comparative | M-2 | — | — | — | — | — | — | 78 | 85 | 1.68 |
| Example 8 | | | | | | | | | | |
| Comparative | M-10 | — | — | — | — | — | — | 87 | 88 | 1.58 |
| Example 9 | | | | | | | | | | |
| Comparative | M-11 | — | — | — | — | — | — | 87 | 88 | 1.58 |
| Example 10 | | | | | | | | | | |

PM-21: KAYAMER PM-21 (trade name) manufactured by Nippon KayaKu Co., Ltd.
∘: The particles were uniformly dispersed in resin
x: The particles ware aggregated.

As obvious from Table 1, molded articles having a thickness of 1 mm and having high refractivity and good transparency were obtained according to the invention (Examples 1 to 13). On the other hand, the molded articles with titanium oxide dispersed therein were all yellowed and their transparency at a wavelength of 405 nm was low. At a wavelength of 589 nm, the transparency of the molded articles with titanium oxide dispersed therein was lower than that of the molded articles of the invention having a refractive index similar to that of the former (comparison between Examples 1 and 5 with Comparative Examples 2 and 3; and comparison between Example 6 with Comparative Example 4); and the molded articles with titanium oxide dispersed therein having a degree of transparency similar to that of the molded articles of the invention have a lower refractive index (comparison between Example 5 and Comparative Example 5). The transparency of the molded articles with zirconium oxide having a number-average particle size of more than 7 nm lowered, which indicates that the particle size of the zirconium oxide particles to be in the molded articles is preferably at most 7 nm (comparison between Examples 1 and 2 with Comparative Example 1).

The zirconium oxide-containing samples of Examples 1 to 13 of the invention and the titanium oxide-containing samples of Comparative Examples 2 to 4 were subjected to a weather resistance test in which the samples were kept at 60% RH for 90 hours, using Sunshine Weather-o-meter WEL-SU (Suga Test Instruments). After the test, the samples of Comparative Examples 2 to 4 yellowed, but the samples of Examples 1 to 13 of the invention did not turn yellow and their weather resistance was good.

The transparent article and the lens substrate of the invention are lightweight and have high refractivity and good transparency. According to the invention, a lens having a desired refractive index can be provided relatively easily. In addition, a lens having good mechanical strength and good heat resistance can also be provided with ease. Accordingly, the invention is useful for providing wide-range optical structures such as high-refractivity lenses, and its industrial applicability is great.

The present disclosure relates to the subject matter contained in Japanese Patent Application No. 5600/2006 filed on Jan. 13, 2005 and Japanese Patent Application No. 346114/2006 filed on Dec. 22, 2006, which are expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A transparent article having a thickness of at least 0.5 mm, which comprises fine particles containing zirconium oxide as a main component in a resin and has a light transmittance of at least 60% at a wavelength of 405 nm and at least 70% at a wavelength of 589 nm in terms of the article having a thickness of 1 mm.

2. The transparent article according to claim 1, which contains at least 30% by mass of the fine particles containing zirconium oxide as a main component.

3. The transparent article according to claim 1, wherein the fine particles containing zirconium oxide as a main component have a number-average particle size of from 1 to 7 nm.

4. The transparent article according to claim 1, which has a refractive index at a wavelength of 589 nm of at least 1.7.

5. The transparent article according to claim 1, which contains a compound having a group selected from 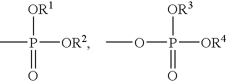
wherein R¹, R², R³and R⁴each independently represents a hydrogen atom or a substituted or unsubstituted alkyl group; —SO₃H; —OSO₃H; and —CO₂H.

6. The transparent article according to claim 1, wherein the resin has a refractive index of from 1.58 to 1.80.

7. A lens substrate comprising a transparent article of claim 1.

8. A method for producing a transparent article having a thickness of at least 0.5 mm and having a light transmittance of at least 60% at a wavelength of 405 nm and at least 70% at a wavelength of 589 nm in terms of the article having a thickness of 1 mm; which comprises dispersing fine particles containing zirconium oxide as a main component in a resin.

9. The method for producing a transparent article of claim 8, wherein the fine particles have a number-average particle size of from 1 to 7 nm.

10. The method for producing a transparent article of claim 8, wherein the fine particles are dispersed in a resin in the presence of a dispersant.

11. The method for producing a transparent article of claim 10, wherein the dispersant is a compound having a group selected from 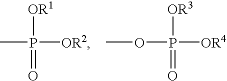
wherein R¹, R², R³ and R⁴ each independently represents a hydrogen atom or a substituted or unsubstituted alkyl group; —SO₃H; —OSO₃H; and —CO₂H.
